(19) United States
(12) Patent Application Publication
(10) Pub. No.: US 2024/0303025 A1
(43) Pub. Date: Sep. 12, 2024

(54) SCREEN SHARING VIEWERSHIP VERIFICATION

(71) Applicant: INTERNATIONAL BUSINESS MACHINES CORPORATION, ARMONK, NY (US)

(72) Inventors: Paritosh Ranjan, Kolkata (IN); BHUBANESWAR PADHAN, Kolkata (IN); Prosanta Saha, Kolkata (IN); PRODIP ROY, Kolkata (IN)

(21) Appl. No.: 18/181,788

(22) Filed: Mar. 10, 2023

(51) Int. Cl. G06F 3/14; G06T 1/00; G06V 30/10

(52) U.S. Cl. CPC G06F 3/1462; G06T 1/005; G06T 1/0085; G06V 30/10; G06T 2201/0065; G06V 2201/02

(57) ABSTRACT

A method, computer system, and a computer program product for screen sharing viewership verification is provided. The present invention may include generating a watermark data for a screen sharing session. The present invention may include dynamically modifying a visual content shared by a presenter device in the screen sharing session to include the watermark data. The present invention may include displaying, on an attendee device, the visual content modified with the watermark data. The present invention may include periodically capturing a screenshot of a displayed content of the attendee device in the screen sharing session. The present invention may include generating a watermark detection information by checking for the watermark data in the screenshot of the displayed content on the attendee device. The present invention may include displaying, on the presenter device, a viewership verification information associated with the attendee device, based on the watermark detection information.

### BACKGROUND

The present invention relates generally to the field of computing, and more particularly to collaborative computing sessions.

Web conferencing has become a staple mode of enterprise collaboration. A web conference may be supported by a network of servers and client computers and allow web-connected computer users to communicate via a communication network over geographically distant locations. Participants in a web conference may join an online meeting session to take part in video conferencing, virtual whiteboarding, and screen sharing activities. These online meeting sessions may enable data streams of audio and/or video signals to be communicated between participant devices in real-time.

### SUMMARY

Embodiments of the present invention disclose a method, computer system, and a computer program product for screen sharing viewership verification. The present invention may include generating a watermark data for a screen sharing session. The present invention may include dynamically modifying a visual content shared by a presenter device in the screen sharing session to include the watermark data. The present invention may include displaying, on an attendee device, the visual content modified with the watermark data. The present invention may include periodically capturing a screenshot of a displayed content of the attendee device in the screen sharing session. The present invention may include generating a watermark detection information by checking for the watermark data in the screenshot of the displayed content on the attendee device. The present invention may include displaying, on the presenter device, a viewership verification information associated with the attendee device, based on the watermark detection information.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a web conferencing environment according to at least one embodiment;

FIG. 3 is a schematic block diagram of a graphical user interface (GUI) of the web conferencing environment according to at least one embodiment;

FIG. 4 is a schematic block diagram of outputs for determining content viewing percentage by one or more attendees of the web conferencing environment according to at least one embodiment; and

FIG. 5 is an operational flowchart illustrating an exemplary screen sharing viewership verification process of the web conferencing environment according to at least one embodiment.

### DETAILED DESCRIPTION

The following described exemplary embodiments provide a system, method, and computer program product for verifying viewership of a shared visual content in a screen sharing session of an online meeting. As such, the present embodiment has the capacity to improve the technical field of collaborative computing sessions by providing an ability to remotely detect which attendees of an online meeting are viewing the shared visual content and which attendees are not viewing the shared visual content, either fully or partially. More specifically a conference program may generate a watermark data for a screen sharing session. Then the conference program may dynamically modify a visual content shared by a presenter device in the screen sharing session to include the watermark data. Next, the conference program may display, on an attendee device, the visual content modified with the watermark data in the screen sharing session. Next, the conference program may periodically capture a screenshot of a displayed content on the attendee device in the screen sharing session. Then, the conference program may generate a watermark detection information by checking for the watermark data in the screenshot of the displayed content on the attendee device. Thereafter, the conference program may display, on the presenter device, a viewership verification information associated with the attendee device, based on the watermark detection information.

As described previously, web conferencing has become a staple mode of enterprise collaboration. A web conference may be supported by a network of servers and client computers and allow web-connected computer users to communicate via a communication network over geographically distant locations. Participants in a web conference may join an online meeting session to take part in video conferencing, virtual whiteboarding, and screen sharing activities. These online meeting sessions may enable data streams of audio and/or video signals to be communicated between participant devices in real-time.

In an online meeting, attendees may be multitasking and not actively following the visual content being shared by the presenter and displayed on the attendee device in a screen sharing session. The attendees may have either minimized the visual content on their device or may have some other content in front of the window displaying the shared visual content.

However, in certain cases, it may be important for all or specific attendees to view the shared visual content provided by the presenter. For example, the online meeting may include a training session, or there may be a need for subject matter experts to watch the visual content at specific points to provide their expert input and analysis. It may also be important for the presenter to determine whether the shared visual content is visible to all of the attendees before starting a discussion in the online meeting.

Therefore, it may be advantageous to, among other things, provide a way to verify viewership of the shared visual content in the screen sharing session of the online meeting. Embodiments of the present disclosure provides a solution to achieve viewership verification without violating the privacy of the attendees in an online meeting.

According to one embodiment, a conference program may enable a participant (e.g., presenter) in an online meeting to initiate a screen sharing session to share a visual content (e.g., screen content, application content) displayed on the participant's device screen (e.g., a screen of a presenter device). In one embodiment, the visual content including video frames of the presenter's screen may start streaming to an online meeting server also running the conference program. In one embodiment, the conference program running on the online meeting server may generate a watermark data to add to the frames of the video passing from the presenter device to one or more attendee devices associated with respective attendees (e.g., viewers). In one embodiment, the watermark data may include a unique identifier (UID), such as, for example, universally unique identifier (UUID) associated with the presenter and/or the screen sharing session. In one embodiment, the conference program may display a sequence of the video frames of the presenter's screen including the watermark data (e.g., UID) on displays associated with the attendee devices.

According to one embodiment, the online meeting server may also separately share the watermark data directly with the online meeting client application running on the attendee devices. In one embodiment, periodically (e.g., at specific intervals of every 5 seconds, 15 seconds as configured by a meeting host or the presenter), the conference program may implement he online meeting client application running on the attendee devices to capture a screenshot of respective screens of the attendee devices and convert the captured screenshot to text via Optical Character Recognition (OCR). The online meeting client application may then search for the watermark data in the text converted via OCR. If the same watermark data is detected by the client application in the text converted via OCR, then the client application may record that the watermark data was detected at that point in time. If the same watermark data was not found in the screenshot, then the client application may record that the watermark data was not detected at that point in time. In one embodiment, the watermark data detection in the screenshot may also be performed using artificial intelligence techniques (e.g., computer vision algorithms).

In one embodiment, the detection information may be shared by the online meeting client application to the online meeting server by each attendee device. Then, the online meeting server may convert this detection information into a viewership verification information and share the viewership verification information with the online meeting client application of the presenter device. In one embodiment, the online meeting client application of the presenter device may display, based on the viewership verification information, a graphical icon against each attendee in a graphical attendee list to showcase which attendees are watching the visual content of the shared screen and which attendees are not.

According to one embodiment, at the time of starting the screen share, the presenter device may configure the number of watermark data to add to the visual content (e.g., frames of video stream) and the positions of the watermark data to be added to the presenter's video frames.

For example, the presenter may decide to have four watermarks at the four corners of the video frame. So, in this case, if the online meeting client application detects four instances of the watermark data on the viewer attendee's screenshot, then the attendee may be determined to be watching 100% of the shared content. If the online meeting client application detects three instances of the watermark data on the viewer attendee's screenshot, then the attendee may be determined to be watching 75% of the shared content. If the online meeting client application detects two instances of the watermark data on the viewer attendee's screenshot, then the attendee may be determined to be watching 50% of the shared content. If the online meeting client application detects one instance of the watermark data on the viewer attendee's screenshot, then the attendee may be determined to be watching 25% of the shared content. And if the online meeting client application detects zero instances of the watermark data on the viewer attendee's screenshot, then the attendee may be determined to be watching 0% of the shared content.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

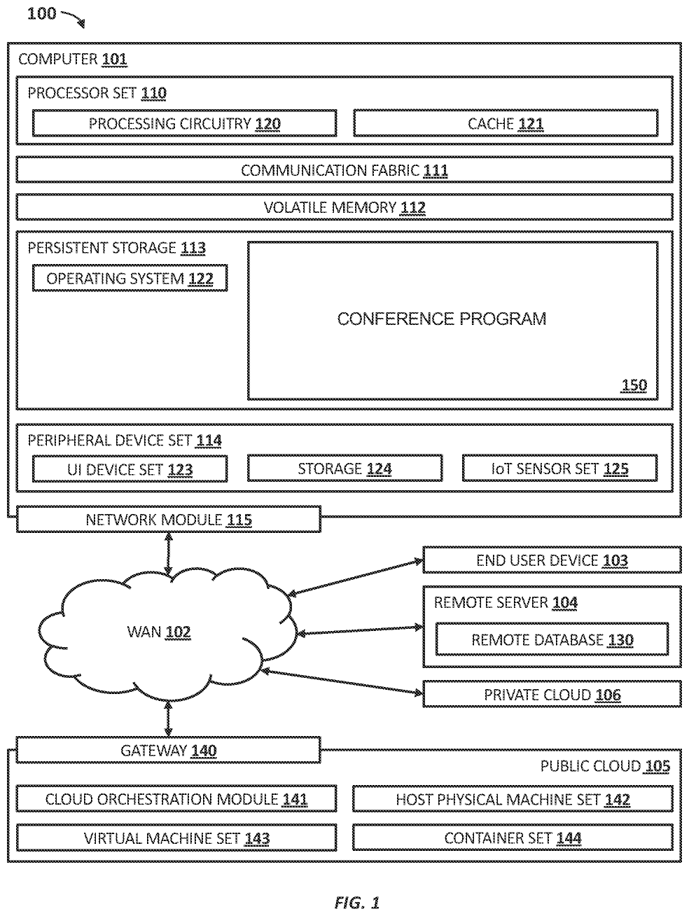

Referring to FIG. 1, a computing environment 100 according to at least one embodiment is depicted. Computing environment 100 contains an example of an environment for the execution of at least some of the computer code involved in performing the inventive methods, such as conference program 150. In addition to conference program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and conference program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, conference program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The conference program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

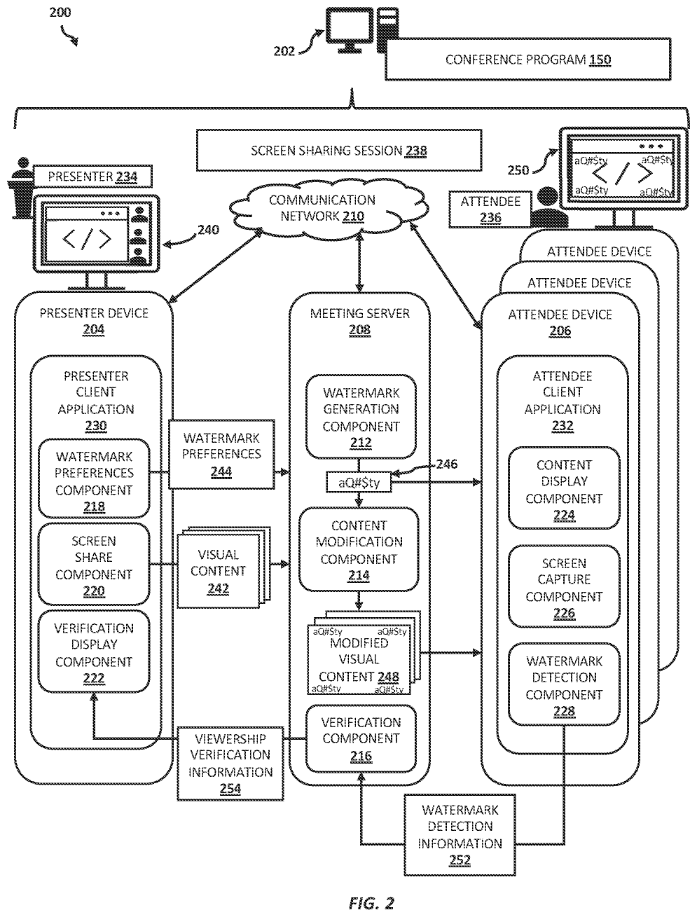

According to the present embodiment, a user using any combination of an EUD 103, remote server 104, public cloud 105, and private cloud 106 may use the conference program 150 to verify viewership of the shared visual content in the screen sharing session of the online meeting. Embodiments of the present disclosure are explained in more detail below with respect to FIGS. 2 to 5.

Referring now to FIG. 2, a schematic block diagram of a web conferencing environment 200 according to at least one embodiment is depicted. According to one embodiment, the web conferencing environment 200 may include a computer system 202 having a tangible storage device and a processor that is enabled to run the conference program 150.

Generally, the computer system 202 may be enabled by the conference program 150 to generate a watermark data for a screen sharing session, dynamically modify a visual content shared by a presenter device in the screen sharing session to include the watermark data, display, on an attendee device, the visual content modified with the watermark data in the screen sharing session, periodically capture a screenshot of a displayed content on the attendee device in the screen sharing session, generate a watermark detection information by checking for the watermark data in the screenshot of the displayed content on the attendee device, and display, on the presenter device, a viewership verification information associated with the attendee device, based on the watermark detection information.

According to one embodiment, the computer system 202 may include one or more components (e.g., computer 101; end user device (EUD) 103; WAN 102; remote server 104) of the computer environment 100 described above with reference to FIG. 1. In one embodiment, the computer system 202 may include one or more computers (e.g., computer 101) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database.

According to one embodiment, the computer system 202 may include at least one presenter device 204 (e.g., EUD 103), at least one attendee device 206 (e.g., EUD 103), and at least one meeting server 208 (e.g., computer 101). In at least one embodiment, aspects of the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the conference program 150 may include a single computer program or multiple program modules or sets of instructions being executed by the processor of the computer system 202 (e.g., presenter device 204, attendee device 206, meeting server 208). In one embodiment, the conference program 150 may include routines, objects, components, units, logic, data structures, and actions that may perform particular tasks or implement particular abstract data types. In one embodiment, the conference program 150 may be practiced in distributed cloud computing environments where tasks may be performed by local and/or remote processing devices which may be linked through a communication network 210 (e.g., WAN 102). In at least one embodiment, the conference program 150 (e.g., the various components) may be executed on a single computing device (e.g., presenter device 204) and/or on the presenter device 204 and attendee device 206, without the meeting server 208.

According to one embodiment, the at least one presenter device 204, at least one attendee device 206, and at least one meeting server 208 may be communicatively coupled via the communication network 210. The communication network 210 may include various types of communication networks, such as the wide area network (WAN) 102, described with reference to FIG. 1. In some embodiments, the WAN may be replaced and/or supplemented by a local area network (LAN), a telecommunication network (e.g., 3G, 4G, 5G), a wireless network, a public switched network and/or a satellite network.

According to one embodiment, the conference program 150 may include a watermark generation component 212, a content modification component 214, a verification component 216, a watermark preferences component 218, a screen share component 220, a verification display component 222, a content display component 224, a screen capture component 226, and a watermark detection component 228, among others.

In one embodiment, the conference program 150 may implement the meeting server 208 to execute the watermark generation component 212, the content modification component 214, and the verification component 216. In one embodiment, the conference program 150 may implement a presenter client application 230 running on the presenter device 204 to execute the watermark preferences component 218, the screen share component 220, and the verification display component 222. In one embodiment, the conference program 150 may implement an attendee client application 232 running on the attendee device 206 to execute the content display component 224, the screen capture component 226, and the watermark detection component 228. While the various components of the conference program 150 are described to be executed on the respective devices (e.g., presenter device 204, attendee device 206, meeting server 208) noted above, in at least one embodiment, each of the presenter device 204, the attendee device 206, and the meeting server 208, may be implemented to execute all of the components of the conference program 150. For example, the presenter device 204 and/or the attendee device 206 may additionally be implemented to execute the watermark generation component 212, the content modification component 214, and the verification component 216 described to be executed by the meeting server 208.

According to one embodiment, the conference program 150 may enable a presenter 234 associated with the presenter device 204, an attendee 236 associated with the attendee device 206, or any other meeting administrator (e.g., a host associated with a host device which is not illustrated) to initiate a screen sharing session 238 in the web conferencing environment 200.

In one embodiment, the screen share component 220 of the presenter client application 230 may enable the presenter 234 to share a presenter screen 240 in the screen sharing session 238. In one embodiment, the presenter screen 240 may be shared as a visual content 242, which may include a single image and/or a plurality of frames of a video stream. While not illustrated in FIG. 2, in various embodiments, the visual content 242 may additionally include an audio stream. In one embodiment, the visual content 242 shared by the presenter device 204 may be transmitted to the meeting server 208.

According to one embodiment, the watermark preferences component 218 of the presenter client application 230 may enable the presenter 234 to select and transmit one or more watermark preferences 244 to the meeting server 208. The watermark preferences 244 may include a presenter-selected number of instances of a watermark data 246 to be included in the visual content 242 and/or a presenter-selected watermark placement pattern for placing the watermark data 246 in the visual content 242.

According to one embodiment, the conference program 150 may implement the meeting server 208 to execute the watermark generation component 212 to generate the watermark data 246 for the screen sharing session 238. In one embodiment, the watermark data 246 may be generated as a unique identifier (UID) including a unique textual data, a unique image data, and/or a unique combination of textual and image data. In one embodiment, the UID may include a universally unique identifier (UUID). For example, the watermark data 246 is illustrated in FIG. 2 as the UID “aQ #$ty.” In one embodiment, the conference program 150 may implement the meeting server 208 to transmit the watermark data 246 directly to the attendee client application 232 running on the attendee device 206.

According to one embodiment, the conference program 150 may implement the meeting server 208 to execute the content modification component 214 to dynamically modify the visual content 242 with the watermark data 246, in real-time, as the visual content 242 is received from the presenter device 204. In one embodiment, the content modification component 214 may output a modified visual content 248 to include any total number of the watermark data 246 in various placement patterns. In one embodiment, the total number of instances of the watermark data 246 and/or the placement pattern may be set as a default. In at least one embodiment, the total number of instances of the watermark data 246 and/or the placement pattern may be determined based on the watermark preferences 244 received from the presenter device 204. For example, the content modification component 214 may generate the modified visual content 248 to include a total of four instances of the watermark data 246 in each of the four corners of a frame of the visual content 242, as illustrated in FIG. 2. This total number of instances and placement pattern may be the default setting of the conference program 150 or may be determined by the watermark preferences 244 received from the presenter device 204.

In one embodiment, the content modification component 214 may add the watermark data 246 to each frame of the plurality of frames of the video stream (e.g., visual content 242). In at least one embodiment, the content modification component 214 may add the watermark data 246 to a lesser number of frames than the plurality of frames of the video stream (e.g., visual content 242) to save on computing resources. In one embodiment, adding the watermark data 246 to the lesser number of frames may include adding the watermark data 246 to a specific interval of frames of the plurality of frames (e.g., every other frame; every third frame).

According to one embodiment, the conference program 150 may implement the meeting server 208 to transmit the modified visual content 248 including the watermark data 246 to the attendee client application 232 running on the attendee device 206. In one embodiment, the conference program 150 may implement the attendee device to execute the content display component 224 to display the modified visual content 248 on an attendee screen 250 of the attendee device 206. In one embodiment, the modified visual content 248 may be displayed on the attendee device 206 in real-time as the visual content 242 is being shared by the presenter device 204.

According to one embodiment, the conference program 150 may implement the attendee device 206 to execute the screen capture component 226 to take a screenshot of the attendee screen 250 including all displayed content on the attendee screen 250. In one embodiment, the screen capture component 226 may capture the screenshot, periodically at specific intervals of time (e.g., every five seconds; every 30 seconds). In one embodiment, the screenshot interval may be set at a default interval by the conference program 150 and/or may be selected by the presenter enabled by the watermarks preferences component 218 of the presenter client application 230. As such, a presenter-selected screenshot interval may be included in the watermarks preferences 244 transmitted to the meeting server 208 and forwarded to the attendee client application 232.

According to one embodiment, the conference program 150 may implement the attendee device 206 to execute the watermark detection component 228 to analyze the screenshot of the displayed content of the attendee device 206 (e.g., in the attendee screen 250) to determine whether the watermark data 246 transmitted to the attendee device 206 (e.g., separately from the modified visual content 248 including the watermark data 246) is detected in the screenshot of the displayed content. In one embodiment, the watermark detection component 228 may determine whether the watermark data 246 received from the meeting server 208 includes a textual data. If textual data is determined in the watermark data 246 by the watermark detection component 228, the watermark detection component 228 may implement optical character recognition (OCR) techniques and use text comparison to search for the watermark data 246 in the screenshot of the displayed content of the attendee device 206. However, if the watermark detection component 228 determines that the watermark data 246 received from the meeting server 208 includes at least one image data (e.g., only image data or text data and image data), the watermark detection component 228 may implement computer vision techniques (e.g., AI algorithm) and image comparison (e.g., using the watermark data 246 as an image template) to search for the watermark data 246 in the screenshot of the displayed content of the attendee device 206.

According to one embodiment, an output of the watermark detection component 228 may include the watermark detection information 252. In one embodiment, the watermark detection information 252 may indicate a presence or absence of the watermark data 246 in the screenshot of the displayed content of the attendee device 206. In one embodiment, the watermark detection information 252 may also indicate a visible number of instances of the watermark data 246 detected in the screenshot of the displayed content of the attendee device 206. In order to protect the privacy of the attendee 236, the watermark detection information 252 may not include an actual screenshot of the displayed content of the attendee device 206.

According to one embodiment, the conference program 150 may implement the attendee client application 232 to transmit the watermark detection information 252 to the meeting server 208. In one embodiment, the verification component 216 of the conference program 150 running on the meeting server 208 may receive the watermark detection information 252 from the attendee device 206. In one embodiment, the verification component 216 may use the watermark detection information 252 to generate a viewership verification information 254 associated with the attendee device 206. In one embodiment, the viewership verification information 254 may indicate whether the attendee 236 associated with the attendee device 206 is currently watching/viewing the modified visual content 248 (e.g., the visual content 242 shared by the presenter device 204 and modified to include the watermark data 246). In one embodiment, the viewership verification information 254 may also indicate what percentage of the modified visual content 248 is currently being watched/viewed by the attendee 236 associated with the attendee device 206 (e.g., visible in the displayed content of the attendee device 206). In one embodiment, the percentage of the modified content 248 (e.g., visual content 242 modified with watermark data 246) that is visible in the displayed content of the attendee device 206 may be determined by comparing the visible number of watermark data 246 detected in the screenshot by the watermark detection component 228 and the total number of instances of the watermark data 246 included in the modified visual content 248. In one embodiment, the total number of instances of the watermark data 246 may be a default number set by the conference program 150 or may be determined by the presenter-selected number of instances in the watermark preferences 244. For example, if the total number of instances of the watermark data 246 included in the modified visual content 248 is six and the visible number of watermark data 246 detected in the screenshot by the watermark detection component 228 is two, the verification component 216 may determine that the attendee 236 is currently viewing 33% of the modified content 248.

According to one embodiment, the conference program 150 may implement the presenter client application 230 running on the presenter device 204 to execute the verification display component 222 to display the viewership verification information 254 on the presenter screen 240. In one embodiment, the verification display component 222 may graphically display the viewership verification information 254 such that the presenter 234 may see which attendees 236 are currently viewing the visual content 242 shared by the presenter device 204. In one embodiment, the verification display component 222 may graphically display the viewership verification information 254 such that the presenter 234 may see what percentage of the visual content 242 is currently being viewed by each of the attendees 236. In one embodiment, the verification display component 222 may dynamically change the displayed viewership verification information 254 as updated watermark detection information 252 is received from the attendee client application 232 running on the attendee device 206. For example, the conference program 150 may enable the presenter 234 to graphically see on the presenter device 204, that an attendee 236 who was initially viewing 100% of the visual content 242 is currently viewing only 50% of the visual content 242 because 50% of the watermark data 246 in the modified visual content 248 was detected in the screenshot of the displayed content on the attendee device 206. In one embodiment, the presenter 234 may use this viewership verification information 254 to determine the interest of the attendees in the visual content 242 in real-time and may make changes to the presentation to engage the attendees 236 to view the visual content 242.

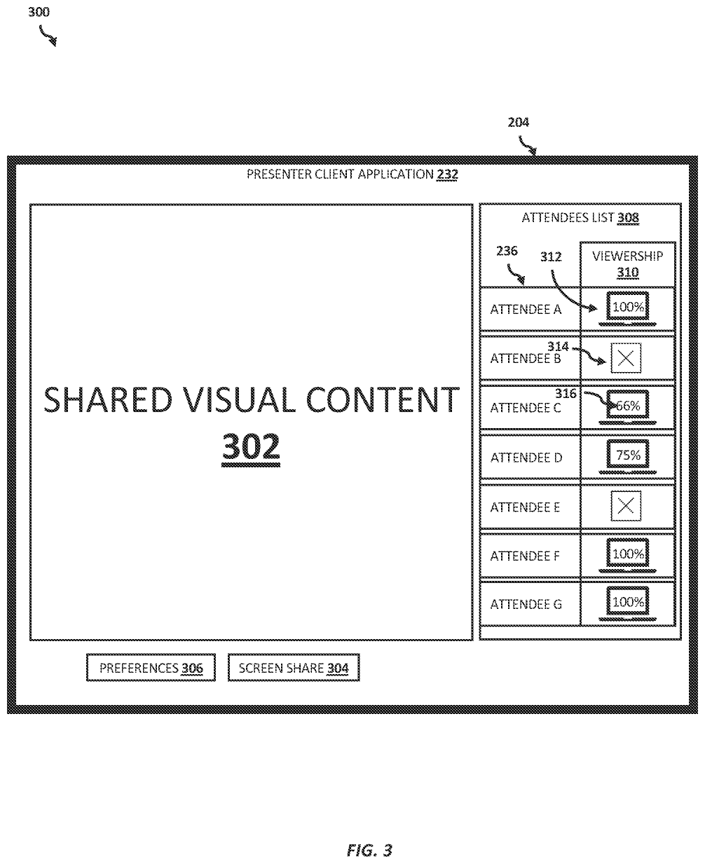

Referring now to FIG. 3, a schematic block diagram of a graphical user interface (GUI) 300 according to at least one embodiment is depicted. FIG. 3 provides a description of the GUI 300 with reference to the web conferencing environment 200 (FIG. 2).

According to one embodiment, the GUI 300 may be implemented by the presenter client application 230 of the conference program 150 running on the presenter device 204. In one embodiment, the GUI 300 of the presenter client application 230 may display a shared visual content 302 which may include the visual content 242 shared by the presenter device 204 in the screen sharing session 238.

In one embodiment, the GUI 300 may include a screen share tool 304 which may be provided by the screen share component 220 of the presenter client application 230, as described previously with reference to FIG. 2. In one embodiment, the screen share tool 304 may enable the presenter 234 to share the visual content 242 (e.g., shared visual content 302) in the screen sharing session 238.

In one embodiment, the GUI 300 may include a preferences tool 306 which may be provided by the watermark preferences component 218, as described previously with reference to FIG. 2. In one embodiment, the preferences tool 306 may enable the presenter 234 to share one or more watermark preferences 244 with the meeting server 208.

In one embodiment, the GUI 300 may also include an attendees list 308 which may list a name of all the attendees 236 (e.g., Attendee A-G) in the screen sharing session 238. In one embodiment, the GUI 300 may further include a viewership tool 310 which may be provided by the verification display component 222 of the presenter client application 230, as described previously with reference to FIG. 2. In one embodiment, the verification display component 222 may graphically display the viewership verification information 254 in the viewership tool 310. In one embodiment, the viewership tool 310 may display a first icon 312 linked to each attendee 236 (e.g., Attendee A, C, D, F, G) that is currently watching the shared visual content 302. In one embodiment, the first icon 312 may also include a first color. In one embodiment, the viewership tool 310 may display a second icon 314 linked to each attendee 236 (e.g., Attendee B, E) that is currently not watching the shared visual content 302. In one embodiment, the second icon 314 may also include a second color. In other embodiments, the viewership tool 310 may display no icon linked to each attendee 236 that is currently not watching the shared visual content 302. In at least one embodiment, the viewership tool 310 may also display a percentage 316 linked to the attendees 236 indicating what percentage of the shared visual content 302 is currently being viewed by those attendees 236. In one embodiment, the percentage 316 may be indicated in other forms (e.g., a fraction; other graphical icon). In one embodiment, if the attendee 236 is currently not watching the shared visual content 302, the viewership tool 310 may not display any percentage 316 linked to that attendee 236. In one embodiment, if the attendee 236 is currently watching the shared visual content 302, the viewership tool 310 may only display the percentage 316 linked to the attendee 236 without the first icon 312. In one embodiment, the viewership tool 310 may dynamically change one or more indicators (e.g., first icon 312, second icon 314, percentage 316) linked to the attendees 236 as new viewership verification information 254 is received by the verification display component 222. In one embodiment, the viewership tool 310 may be visible to the presenter 234 in the presenter client application 232 as the presenter 234 is discussing the shared visual content 302.

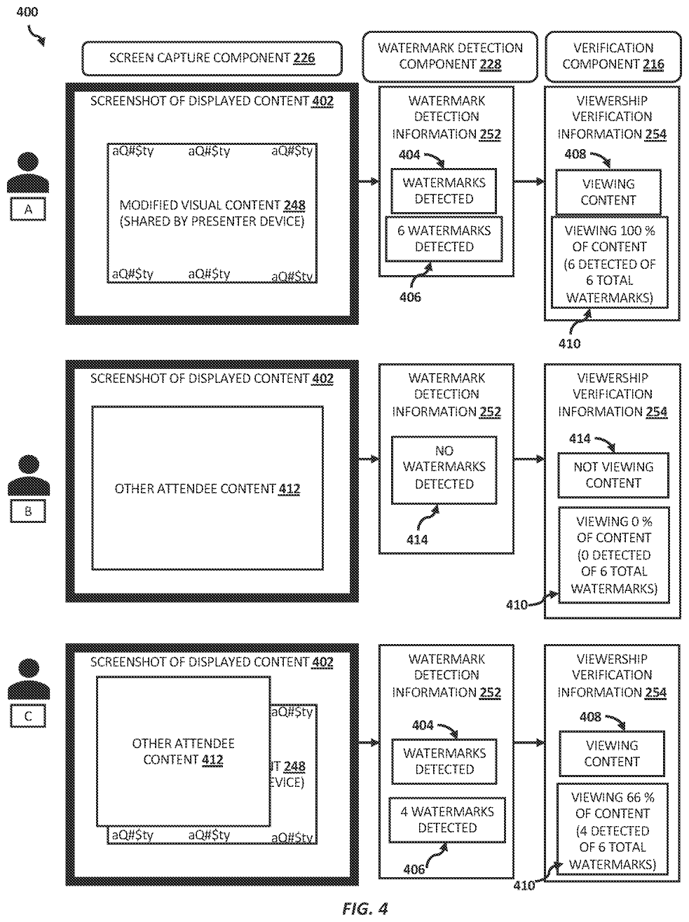

Referring now to FIG. 4, a schematic block diagram of outputs 400 of the conference program 150 for determining content viewing percentage by one or more attendees according to at least one embodiment is depicted. FIG. 4 provides a description of outputs 400 with reference to the web conferencing environment 200 (FIG. 2) and the GUI 300 (FIG. 3). FIG. 4 illustrates determining the content viewing percentage associated with exemplary Attendees A, B, and C, respectively.

For Attendee A, the screen capture component 226 of the attendee client application 232 running on attendee device 206 (of Attendee A), may output a screenshot of displayed content 402. In this example, the screenshot of the displayed content 402 may include the modified visual content 248 without any other obstructing content. The watermark detection component 228 of the attendee client application 232 may output the watermark detection information 252 based on analyzing the screenshot of displayed content 402 using OCR and/or computer vision techniques. In one embodiment, the watermark detection information 252 may include a positive detection indication 404 (e.g., watermarks detected) and a visible number indication 406 (e.g., 6 watermarks detected). In one embodiment, the verification component 216 running on the meeting server 208 may receive the watermark detection information 252 and generate the viewership verification information 254. In one embodiment, the viewership verification information 254 may include a positive viewing indication 408 (e.g., viewing content) and a content viewing percentage indication 410. In one embodiment, the percentage of the modified content 248 (e.g., visual content 242 modified with watermark data 246) that is visible in the screenshot of displayed content 402 may be determined by comparing the visible number indication 406 generated by the watermark detection component 228 a total number of instances of the watermark data 246 included in the modified visual content 248. In one embodiment, the total number of instances of the watermark data 246 may be a default number set by the conference program 150 or may be determined by the presenter-selected number of instances in the watermark preferences 244. In one embodiment, the total number of instances of the watermark data 246 included in the modified visual content 248 may be recorded in the meeting server 208 for use by the verification component 216. For example, the viewership verification information 254 may indicate that Attendee A is viewing 100% of the content because 6 instances of the watermark data 246 were detected (e.g., visible number indication 406) out of 6 instances of the watermark data 246 included in the modified visual content 248. In one embodiment, the verification display component 222 of the presenter client application 230 may graphically display the viewership verification information 254 in the viewership tool 310 associated with Attendee A, as illustrated in FIG. 3.

For Attendee B, the screen capture component 226 of the attendee client application 232 running on attendee device 206 (of Attendee B), may output the screenshot of displayed content 402. In this example, the screenshot of the displayed content 402 may display other attendee content 412 and not the modified visual content 248. As such, the watermark detection information 252 generated by the watermark detection component 228 may include a negative detection indication 414 (e.g., no watermarks detected) and no visible number indication 406 since no watermark data 246 was detected in the screenshot of displayed content 402. In one embodiment, the viewership verification information 254 generated based on the watermark detection information 252 may include a negative viewing indication 416 (e.g., not viewing content) and the content viewing percentage indication 410 indicating that Attendee B is viewing 0% of the content since 0 instances of the watermark data 246 were detected out of 6 instances of the watermark data 246 included in the modified visual content 248. In one embodiment, the verification display component 222 of the presenter client application 230 may graphically display the viewership verification information 254 in the viewership tool 310 associated with Attendee B, as illustrated in FIG. 3.

For Attendee C, the screen capture component 226 of the attendee client application 232 running on attendee device 206 (of Attendee C), may output the screenshot of displayed content 402. In this example, the screenshot of the displayed content 402 may display other attendee content 412 partially obstructing the modified visual content 248. As such, the watermark detection information 252 generated by the watermark detection component 228 may include the positive detection indication 404 (e.g., watermarks detected) and the visible number indication 406 indicating that 4 watermark data 246 were detected in the screenshot of displayed content 402. In one embodiment, the viewership verification information 254 generated based on the watermark detection information 252 may include the positive viewing indication 408 (e.g., viewing content) and the content viewing percentage indication 410 indicating that Attendee C is viewing 66% of the content since 4 instances of the watermark data 246 were detected out of 6 instances of the watermark data 246 included in the modified visual content 248. In one embodiment, the verification display component 222 of the presenter client application 230 may graphically display the viewership verification information 254 in the viewership tool 310 associated with Attendee C, as illustrated in FIG. 3.

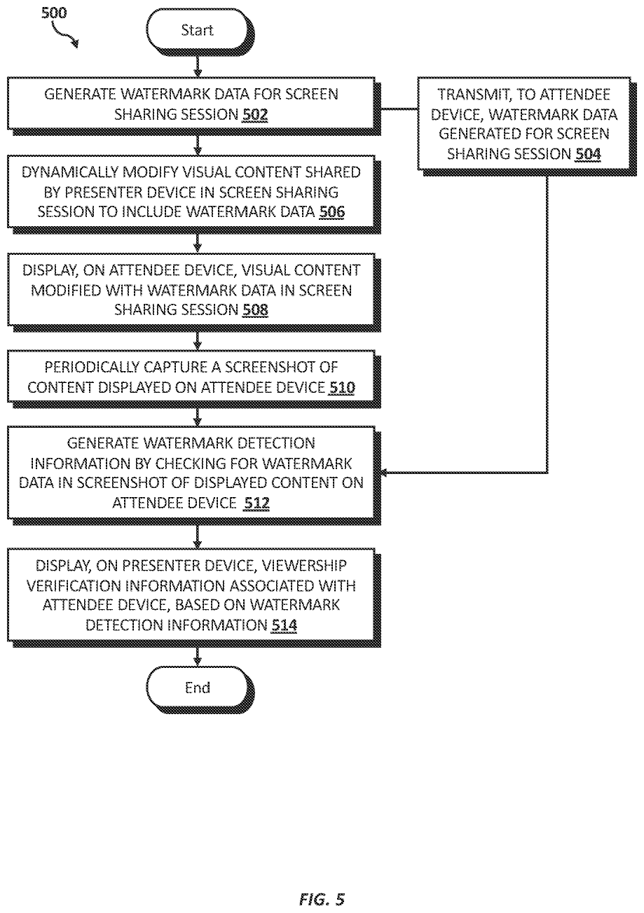

Referring now to FIG. 5, an operational flowchart illustrating an exemplary screen sharing viewership verification process 500 used by the conference program 150 according to at least one embodiment is depicted. FIG. 5 provides a description of process 500 with reference to FIGS. 2-4.

At 502, a watermark data is generated for a screen sharing session. According to one embodiment, the conference program 150 may enable a presenter associated with a presenter device, an attendee associated with an attendee device, or any other meeting administrator (e.g., a host associated with a host device) to initiate the screen sharing session, as described previously with reference to FIG. 2. In one embodiment, the conference program 150 may generate the watermark data for the screen sharing session. In one embodiment, the watermark data may be generated as a unique identifier (UID) including a unique textual data, a unique image data, and/or a unique combination of textual and image data. In one embodiment, the UID may include a universally unique identifier (UUID).

At 504, the watermark data generated for the screen sharing session is transmitted to the attendee device. According to one embodiment, the conference program 150 may transmit the watermark data directly to an attendee client application running on the attendee device and separately from a visual content modified with the watermark data, as described previously with reference to FIG. 2.

At 506, the visual content shared by a presenter device in the screen sharing session is dynamically modified to include the watermark data. According to one embodiment, the conference program 150 may dynamically modify the visual content with the watermark data, in real-time, as the visual content is received from the presenter device, as described previously with reference to FIG. 2. In one embodiment, the conference program 150 may output a modified visual content to include any number of the watermark data in various placement patterns. In one embodiment, the total number of instances of the watermark data and/or the placement pattern may be set as a default. In at least one embodiment, the total number of instances of the watermark data and/or the placement pattern may be determined based on one or more watermark preferences received from the presenter device. In one embodiment, the conference program 150 may add the watermark data to each frame of the plurality of frames of the video stream. In at least one embodiment, the conference program 150 may add the watermark data to a lesser number of frames than a total number of the plurality of frames of the video stream to save on computing resources.

At 508, the visual content modified with the watermark data is displayed on the attendee device in the screen sharing session. According to one embodiment, the conference program 150 may transmit the modified visual content including the watermark data to the attendee client application running on the attendee device. In one embodiment, the conference program 150 may display the modified visual content on an attendee screen of the attendee device. In one embodiment, the modified visual content may be displayed on the attendee device in real-time as the visual content is being shared by the presenter device, as described previously with reference to FIG. 2.

At 510, a screenshot of the content displayed on attendee device is periodically captured. According to one embodiment, the conference program 150 may take a screenshot of the attendee screen including all content displayed on the attendee screen of the attendee device. In one embodiment, the conference program 150 may capture the screenshot, periodically at specific intervals of time (e.g., every five seconds; every 30 seconds). In one embodiment, the screenshot interval may be set at a default interval by the conference program and/or may be selected by the presenter enabled by the conference program 150. In one embodiment, a presenter-selected screenshot interval may be included in the watermarks preferences, as described previously with reference to FIG. 2.

At 512, a watermark detection information is generated by checking of the watermark data in the screenshot of the displayed content on the attendee device. According to one embodiment, the conference program 150 may analyze the screenshot of the displayed content of the attendee device to determine whether the watermark data transmitted to the attendee device (e.g., at 504) is detected in the screenshot of the displayed content. In one embodiment, the conference program 150 may implement optical character recognition (OCR) techniques and use text comparison to search for the watermark data in the screenshot of the displayed content of the attendee device, as described previously with reference to FIG. 2. However, if the conference program 150 determines that the watermark data includes at least one image data (e.g., only image data or text data and image data), the conference program 150 may implement computer vision techniques (e.g., AI algorithm) and image comparison (e.g., using the watermark data as an image template) to search for the watermark data in the screenshot of the displayed content of the attendee device. In one embodiment, the conference program 150 may indicate, in the watermark detection information, whether the watermark data is detected in the screenshot of the displayed content, as described previously with reference to FIGS. 2 and 4. In one embodiment, the conference program 150 may also indicate, in the watermark detection information, a visible number of instances of the watermark data detected in the screenshot of the displayed content of the attendee device. In order to protect the privacy of the attendee, the watermark detection information may not include an actual screenshot of the displayed content of the attendee device.

At 514, a viewership verification information associated with the attendee device, based on the watermark detection information, is displayed on the presenter device. In one embodiment, the conference program 150 may use the watermark detection information to generate the viewership verification information associated with each attendee device. In one embodiment, the viewership verification information may indicate whether the attendee associated with the attendee device is currently watching/viewing the visual content shared by the presenter device and modified to include the watermark data (e.g., modified visual content). In one embodiment, the viewership verification information may also indicate what percentage of the modified visual content is currently being watched/viewed by the attendee associated with the attendee device, as described previously with reference to FIGS. 2 and 4. In one embodiment, the percentage of the modified content that is visible in the displayed content of the attendee device 206 may be determined by comparing the visible number of watermark data detected in the screenshot by the watermark detection component and the total number of instances of the watermark data included in the modified visual content, as described previously with reference to FIGS. 2 and 4. In one embodiment, the total number of instances of the watermark data may be a default number set by the conference program 150 or may be determined by the presenter-selected number of instances in the watermark preferences.

According to one embodiment, the conference program 150 may display the viewership verification information on the presenter screen, as described previously with reference to FIGS. 2 and 3. In one embodiment, the conference program 150 may graphically display the viewership verification information such that the presenter may see which attendees are currently viewing the visual content shared by the presenter device. In one embodiment, the conference program 150 may graphically display the viewership verification information such that the presenter may also see what percentage of the visual content is currently being viewed by each of the attendees. In one embodiment, the conference program 150 may dynamically change the displayed viewership verification information as updated watermark detection information is received from the attendee device, as described previously with reference to FIGS. 2 and 3.

It is contemplated that the conference program 150 may provide several advantages and/or improvements to the technical field of collaborative computing sessions. As described in the present disclosure, the conference program 150 may improve the functionality of a computer because the conference program 150 may enable the computer to provide a way to verify viewership of the shared visual content in the screen sharing session of the online meeting, without violating the privacy of the attendees in the online meeting.

It may be appreciated that FIGS. 2 to 5 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a watermark data for a screen sharing session;
dynamically modifying a visual content shared by a presenter device in the screen sharing session to include the watermark data;
displaying, on an attendee device, the visual content modified with the watermark data in the screen sharing session;
periodically capturing a screenshot of a displayed content of the attendee device in the screen sharing session;
generating a watermark detection information by checking for the watermark data in the screenshot of the displayed content on the attendee device; and
displaying, on the presenter device, a viewership verification information associated with the attendee device, based on the watermark detection information.

2. The computer-implemented method of claim 1, wherein the watermark data generated for the screen sharing session further comprises a unique identifier (UID) selected from the group consisting of a unique textual data, a unique image data, and a unique combination of textual and image data.

3. The computer-implemented method of claim 1, further comprising:
transmitting, to the attendee device, the watermark data generated for the screen sharing session;
analyzing the screenshot of the displayed content of the attendee device to determine whether the watermark data transmitted to the attendee device is detected in the screenshot of the displayed content; and
indicating, in the watermark detection information, whether the watermark data is detected in the screenshot of the displayed content.

4. The computer-implemented method of claim 1, wherein the visual content shared by the presenter device in the screen sharing session further comprises a video stream of a presenter screen associated with the presenter device and the method further comprises:
dynamically modifying, in real-time, a plurality of frames of the video stream to include the watermark data.

5. The computer-implemented method of claim 1, wherein the viewership verification information displayed on the presenter device includes a graphical indication of whether an attendee associated with the attendee device is viewing the visual content.

6. The computer-implemented method of claim 1, wherein dynamically modifying the visual content shared by the presenter device in the screen sharing session to include the watermark data further comprises:
determining a total number of instances of the watermark data for including in the visual content; and
dynamically modifying the visual content to include the total number of instances of the watermark data.

7. The computer-implemented method of claim 1, wherein dynamically modifying the visual content shared by the presenter device in the screen sharing session to include the watermark data further comprises:
determining a presenter-selected watermark placement pattern; and
dynamically modifying the visual content to include the watermark data based on the presenter-selected watermark placement pattern.

8. The computer-implemented method of claim 3, further comprising:
determining that the watermark data transmitted to the attendee device includes a textual data; and
analyzing, using Optical Character Recognition, the screenshot of the displayed content of the attendee device to determine whether the textual data is detected in the screenshot of the displayed content.

9. The computer-implemented method of claim 3, further comprising:
determining that the watermark data transmitted to the attendee device includes an image data; and
analyzing, using computer vision, the screenshot of the displayed content of the attendee device to determine whether the image data is detected in the screenshot of the displayed content.

10. The computer-implemented method of claim 3, wherein transmitting, to the attendee device, the watermark data generated for the screen sharing session further comprises:
transmitting, to the attendee device, the watermark data separately from the displaying of the visual content modified with the watermark data.

11. The computer-implemented method of claim 4, further comprising:
displaying, on the attendee device, the plurality of frames of the video stream modified to include the watermark data in the screen sharing session.

12. The computer-implemented method of claim 5, wherein the screen sharing session includes a plurality of attendee devices associated with a respective plurality of attendees, and wherein the viewership verification information displayed on the presenter device includes the graphical indication of whether each attendee of the respective plurality of attendees is viewing the visual content.

13. The computer-implemented method of claim 6, wherein generating the watermark detection information by checking for the watermark data in the screenshot of the displayed content of the attendee device further comprises:
determining a visible number of the total number of instances of the watermark data detected in the screenshot of the displayed content of the attendee device.

14. The computer-implemented method of claim 13, wherein displaying the viewership verification information associated with the attendee device further comprises:
indicating a percentage of the visual content that is visible in the displayed content of the attendee device based on the visible number of the total number of instances of the watermark data detected in the screenshot.

15. A computer system for screen sharing viewership verification, comprising:
one or more processors, one or more computer-readable memories and one or more computer-readable storage media;
program instructions, stored on at least one of the one or more storage media for execution by at least one of the one or more processors via at least one of the one or more memories, to generate a watermark data for a screen sharing session;
program instructions, stored on at least one of the one or more storage media for execution by at least one of the one or more processors via at least one of the one or more memories, to dynamically modify a visual content shared by a presenter device in the screen sharing session to include the watermark data;
program instructions, stored on at least one of the one or more storage media for execution by at least one of the one or more processors via at least one of the one or more memories, to display, on an attendee device, the visual content modified with the watermark data in the screen sharing session;
program instructions, stored on at least one of the one or more storage media for execution by at least one of the one or more processors via at least one of the one or more memories, to periodically capture a screenshot of a displayed content of the attendee device in the screen sharing session;
program instructions, stored on at least one of the one or more storage media for execution by at least one of the one or more processors via at least one of the one or more memories, to generate a watermark detection information by checking for the watermark data in the screenshot of the displayed content on the attendee device; and
program instructions, stored on at least one of the one or more storage media for execution by at least one of the one or more processors via at least one of the one or more memories, to display, on the presenter device, a viewership information associated with the attendee device, based on the watermark detection information.

16. The computer system of claim 15, wherein:
the program instructions to generate the watermark data for the screen sharing session further comprises a unique identifier (UID) selected from the group consisting of a unique textual data, a unique image data, and a unique combination of textual and image data.

17. The computer system of claim 15, further comprising:
program instructions, stored on at least one of the one or more storage media for execution by at least one of the one or more processors via at least one of the one or more memories, to transmit, to the attendee device, the watermark data generated for the screen sharing session;
program instructions, stored on at least one of the one or more storage media for execution by at least one of the one or more processors via at least one of the one or more memories, to analyze the screenshot of the displayed content of the attendee device to determine whether the watermark data transmitted to the attendee device is detected in the screenshot of the displayed content; and
program instructions, stored on at least one of the one or more storage media for execution by at least one of the one or more processors via at least one of the one or more memories, to indicate, in the watermark detection information, whether the watermark data is detected in the screenshot of the displayed content.

18. The computer system of claim 15, wherein:
the program instructions to display, on the presenter device, the viewership information associated with the attendee device, based on the watermark detection information further comprises a graphical indication of whether an attendee associated with the attendee device is viewing the visual content.

19. A computer program product for screen sharing viewership verification, comprising:
one or more computer-readable storage media;
program instructions, stored on at least one of the one or more storage media, to generate a watermark data for a screen sharing session;
program instructions, stored on at least one of the one or more storage media, to dynamically modify a visual content shared by a presenter device in the screen sharing session to include the watermark data;
program instructions, stored on at least one of the one or more storage media, to display, on an attendee device, the visual content modified with the watermark data in the screen sharing session;
program instructions, stored on at least one of the one or more storage media, to periodically capture a screenshot of a displayed content of the attendee device in the screen sharing session;
program instructions, stored on at least one of the one or more storage media, to generate a watermark detection information by checking for the watermark data in the screenshot of the displayed content on the attendee device; and
program instructions, stored on at least one of the one or more storage media, to display, on the presenter device, a viewership information associated with the attendee device, based on the watermark detection information.

20. The computer program product of claim 19, wherein:
the program instructions to generate the watermark data for the screen sharing session further comprises a unique identifier (UID) selected from the group consisting of a unique textual data, a unique image data, and a unique combination of textual and image data.
